(19) United States
(12) Patent Application Publication
(10) Pub. No.: US 2026/0104562 A1
(43) Pub. Date: Apr. 16, 2026

(54) OPTICAL MODULE

(71) Applicant: Cloud Light Technology Limited, Hong Kong (HK)

(72) Inventors: Still QIN, Dongguan (CN); Byron Feng, Dongguan (CN)

(21) Appl. No.: 18/927,044

(22) Filed: Oct. 25, 2024

Related U.S. Application Data
(60) Provisional application No. 63/707,493, filed on Oct. 15, 2024.

(51) Int. Cl. G02B 6/42

(52) U.S. Cl. CPC G02B 6/428; G02B 6/4245; G02B 6/426; G02B 6/4262; G02B 6/4272; G02B 6/4277

(57) ABSTRACT

An optical module includes a printed circuit board (PCB) including an upper surface and a bottom surface; an optical port for receiving or transmitting an optical signal; a plurality of elastic bodies; a housing comprising a first housing body and a second housing body fastened to the first housing body to form an enclosure that defines an interior volume of the housing, the PCB arranged within the interior volume, the first housing body including a plurality of first lug bosses configured to be in fitted contact with the upper surface of the PCB, the second housing body including a plurality of second lug bosses each containing a respective elastic body, which protrudes from the second lug boss to make pressure contact with the bottom surface of the PCB; and a hard-constraint fixing mechanism configured to rigidly fix a first end portion of the PCB to the first housing body.

### CROSS-REFERENCE TO RELATED APPLICATION

This Patent Application claims priority to U.S. Provisional Patent Application No. 63/707,493, filed on October 15, 2024, and entitled “OPTICAL MODULE.” The disclosure of the prior Application is considered part of and is incorporated by reference into this Patent Application.

### TECHNICAL FIELD

The present disclosure relates generally to optical modules.

### BACKGROUND

An optical module may have at least one of an optical transmission function or an optical receive function. In general, in order to implement the optical transmission function and the optical receive function, the optical module includes one or a plurality of optical sub-assemblies (OSAs).

An OSA may be configured to convert an electrical signal into an optical signal, or vice versa. For example, an OSA may be used for optical communications in which electrical signals are used to transmit or receive information in a digital format or an analog format. An OSA configured as a transmitter may be configured to convert an electrical signal into an optical signal and transmit the optical signal over an optical fiber connected to the OSA. An OSA configured as a receiver may be configured to receive an optical signal (e.g., the optical signal transmitted by the transmitter OSA) and convert the optical signal back into an electrical signal for signal processing (e.g., demodulation or decoding). An OSA configured as a transceiver that includes both a transmitter and a receiver may be configured to transmit and receive optical signals. An optical fiber may be connected to an OSA by a fiber optic connector.

### SUMMARY

In some implementations, an optical module includes a printed circuit board assembly (PCBA) comprising a printed circuit board (PCB) and one or more optoelectronic components mounted to the PCB, wherein the PCB includes an upper surface and a bottom surface arranged opposite to the upper surface; an optical port for receiving or transmitting an optical signal, wherein the optical port is optically coupled to the one or more optoelectronic components; a plurality of elastic bodies; a housing comprising a first housing body and a second housing body fastened to the first housing body to form an enclosure that defines an interior volume of the housing, wherein the PCBA is arranged within the interior volume, wherein the first housing body includes a plurality of first lug bosses configured to be in fitted contact with the upper surface of the PCB, wherein the second housing body includes a plurality of second lug bosses, and wherein each second lug boss of the plurality of second lug bosses contains a respective elastic body of the plurality of elastic bodies, which protrudes from the second lug boss to make pressure contact with the bottom surface of the PCB; and a hard-constraint fixing mechanism configured to rigidly fix a first end portion of the PCB to the first housing body.

In some implementations, an optical module includes a PCBA comprising a PCB and one or more optoelectronic components mounted to the PCB, wherein the PCB includes an upper surface and a bottom surface arranged opposite to the upper surface; an optical port for receiving or transmitting an optical signal, wherein the optical port is optically coupled to the one or more optoelectronic components; a housing comprising a first housing body and a second housing body fastened to the first housing body to form an enclosure that defines an interior volume of the housing in which the PCBA is arranged, wherein the first housing body includes a plurality of first lug bosses configured to be in fitted contact with the upper surface of the PCB, and wherein the second housing body includes a plurality of second lug bosses configured to be in pressure contact with the bottom surface of the PCB; a hard-constraint fixing mechanism configured to rigidly fix a first end portion of the PCB to the first housing body; and an elastic-constraint fixing mechanism configured to elastically constrain a second end portion of the PCB between the first housing body and the second housing body.

### BRIEF DESCRIPTION OF THE DRAWINGS

FIG. 1A shows an optical module according to one or more implementations.

FIG. 1B shows an exploded view of the optical module.

FIG. 1C shows the optical module, including an underside of a first housing body, and a top side of a second housing body.

FIG. 1D shows a top view of the optical module with a sectional line A-A.

FIG. 1E shows a cross-section of the optical module at sectional line A-A.

FIG. 1F shows an underside of the first housing body with first lug bosses being shown.

FIG. 1G shows a topside of the second housing body.

FIG. 1H shows a zoomed-in view of a region of the second housing body shown in FIG. 1G.

FIG. 1I shows a PCBA with components mounted to a PCB.

FIG. 1J shows the underside of the first housing body and a pull-tab.

### DETAILED DESCRIPTION

The following detailed description of example implementations refers to the accompanying drawings. The same reference numbers in different drawings may identify the same or similar elements.

Typically, an optical module has two housing bodies, covering a printed circuit board assembly (PCBA). A primary function of a housing body is to protect the PCBA and provide heat dissipation for electronic devices mounted to a printed circuit board (PCB) of the PCBA. As a core aspect of the optical module, a fixing method of the PCB in a PCBA can have a large impact on the reliability of the optical module. Optical modules are regularly being improved to increase transmission speeds of optical signals. However, as transmission speeds increase, power consumption also increases, which can lead to increases in heat generation. As a result, working temperatures of devices in PCBAs are rising and approaching an allowable temperature value or temperature tolerance threshold. As a carrier of optoelectronic devices, the PCB will undergo expansion and deformation as the temperature of the PCB increases, with higher temperatures causing a greater amount of expansion and deformation. Thus, the fixing method of the PCB can have a significant impact on product reliability.

In existing optical modules, the PCB may be fastened to a housing body by four screws, with two screws being arranged at opposite ends to fasten the PCB to the housing body. Alternatively, the PCB may be fixed by being squeezed by (e.g., interposed between) two housing bodies. Alternatively, the PCB may be fixed by two screws at one end, with the other, opposite end being squeezed by the two housing bodies. However, the above fixing methods all have hard contact constraints, which may lead to one or more shortcomings. For example, as the PCB expands with increasing temperature, the PCB may arch with deformation, which may affect the stability of optical components and solder joints of electronic devices mounted to the PCB. If the PCB is fixed by being squeezed by two housing bodies, there may be gaps between the two housing bodies due to part tolerance, which may affect the electromagnetic shielding effect of the two housing bodies. If only one end of the PCB is constrained by two screws and an opposite end is unconstrained, although this fixing method may solve the problem of PCB expansion and deformation, this fixing method may cause an amplitude (height) of the free end of the PCB to increase, which may also affect the stability of the optical components and the solder joints of the electronic devices mounted to the PCB. Moreover, long-term vibration can lead to fatigue fracture of component connections. Thus, the fixing methods of PCBs in existing optical modules bring about product reliability issues.

In some implementations, an optical module includes a housing comprising a first housing body and a second housing body, a hard-constraint fixing mechanism configured to rigidly fix a first end portion of a PCB to the first housing body, and an elastic-constraint fixing mechanism configured to elastically constrain a second end portion of the PCB between the first housing body and the second housing body. The elastic-constraint fixing mechanism may include a plurality of elastic bodies configured to provide pressure contact between a bottom surface of the PCB and the second housing body. As a result, the elastic-constraint fixing mechanism may enable thermal expansion of the PCB such that expansion deformation of the PCB is reduced. In addition, the elastic-constraint fixing mechanism may dampen external vibrations to reduce the external vibrations propagating from the housing to the PCB. Thus, the elastic-constraint fixing mechanism may reduce or prevent damage to the PCB, one or more components connected to the PCB, and/or electrical component connections (e.g., traces, ball bonds, bond pads, vias, and/or solder joints) to the one or more components that may otherwise occur due to large expansion deformation. Additionally, the elastic-constraint fixing mechanism may reduce or prevent damage to the PCB, one or more components connected to the PCB, and/or electrical component connections that may otherwise occur due to external vibrations. Thus, the elastic-constraint fixing mechanism in combination with the hard-constraint fixing mechanism may improve a reliability of the optical module and increase a lifetime of the optical module.

Some implementations disclosed herein are directed to an optical module with a PCBA (e.g., a PCB with optical and/or electrical components mounted to the PCB), one or more elastic bodies configured to elastically constrain one end (e.g., a second end) of the PCB, and a hard-constraint fixing mechanism for constraining the other, opposite end (e.g., a first end) of the PCB. The hard-constraint fixing mechanism may include mounting screws arranged at the first end or sandwiching the first end between two hard housing bodies. The fixing method of using the elastic body at the second end and the hard-constraint fixing mechanism at the first end can not only release expansion deformation, but may also provide a damping function by constraining an amplitude of the second end, to solve a problem of device connection fatigue fracture caused by exposure to vibrations over time (e.g., long-term vibrations). In addition, the fixing method may prevent gaps between the housing bodies, which may enable the housing bodies to provide better electromagnetic shielding than would be possible when gaps are present. In other words, the fixing method may enable a more reliable and stable electromagnetic shielding effect. Therefore, existing problems with current fixing methods may be mitigated or resolved.

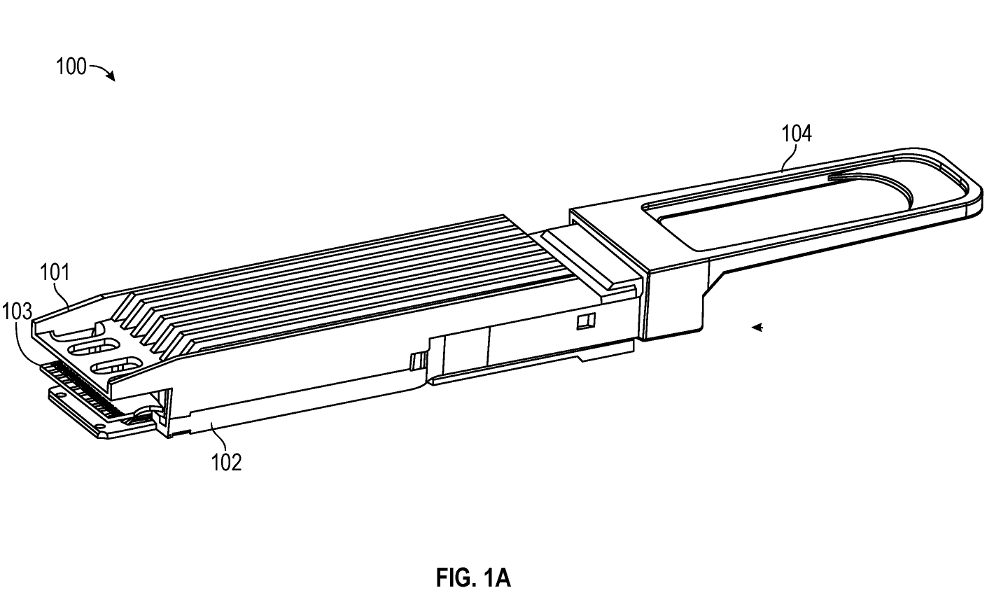

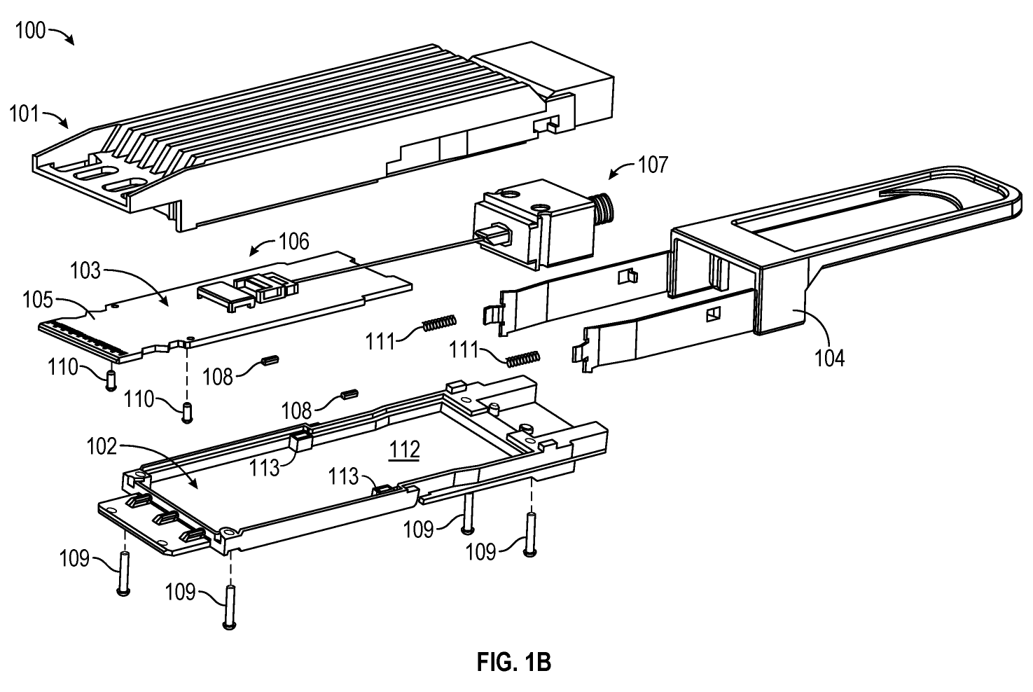

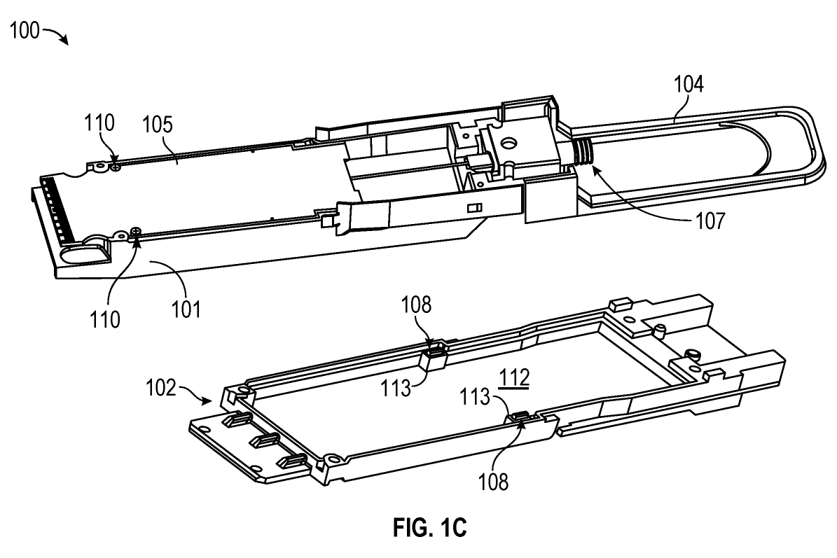

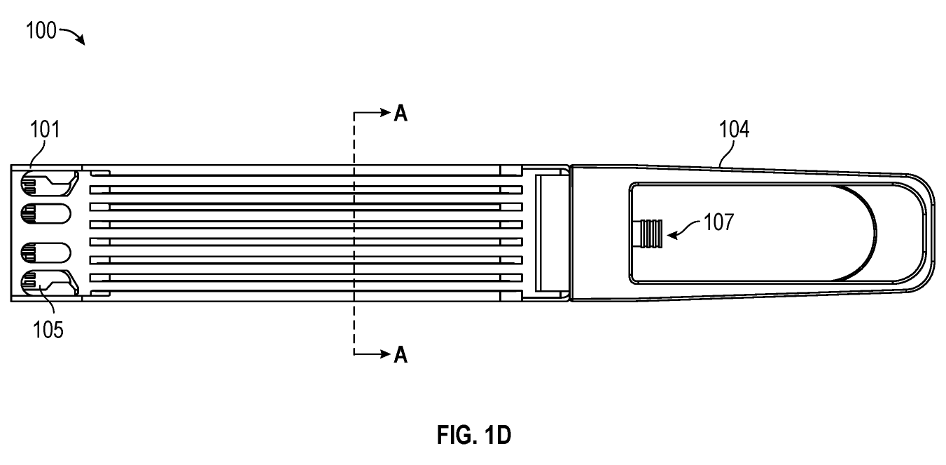

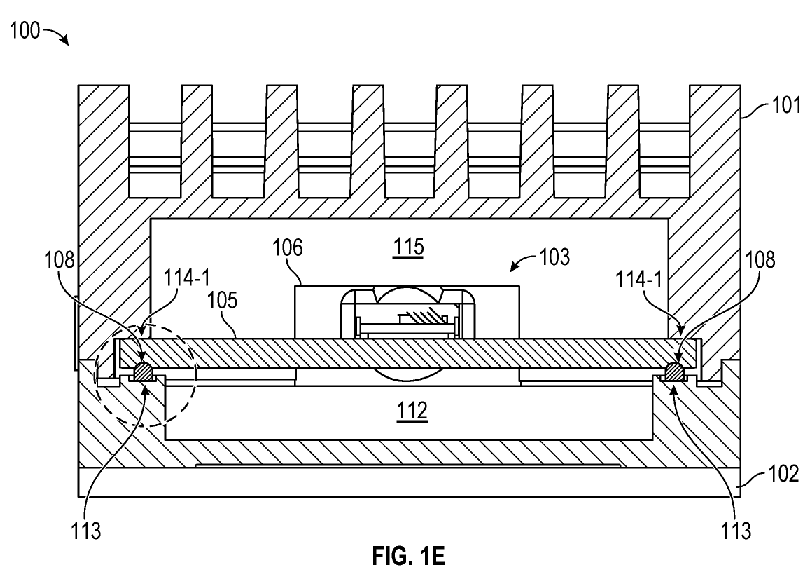

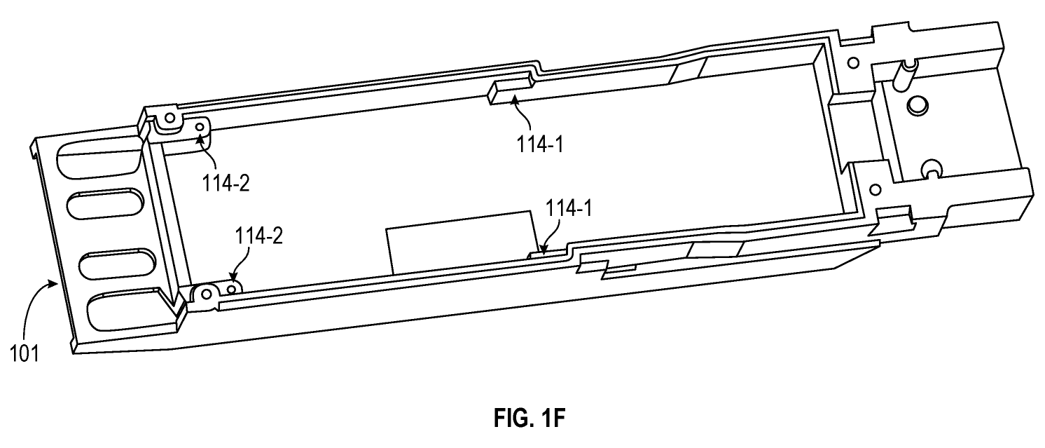

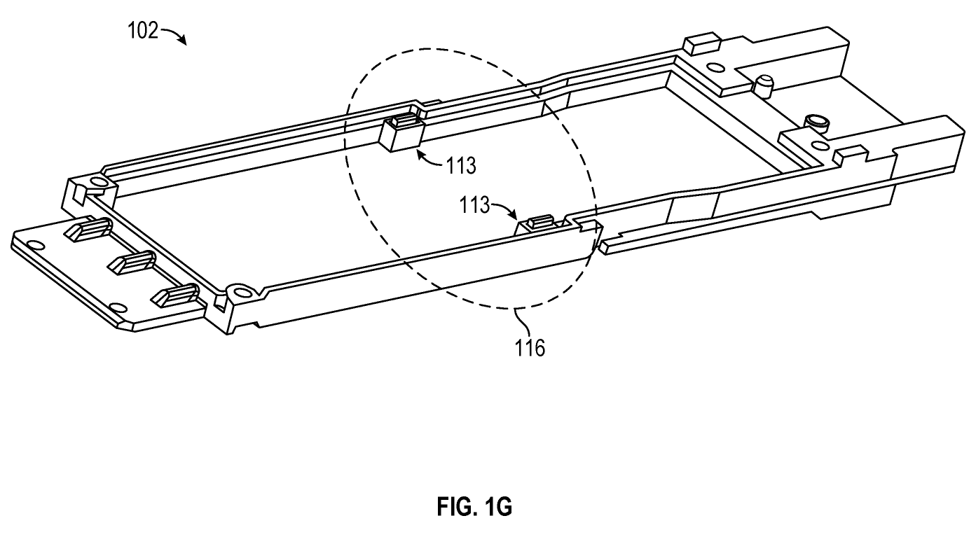

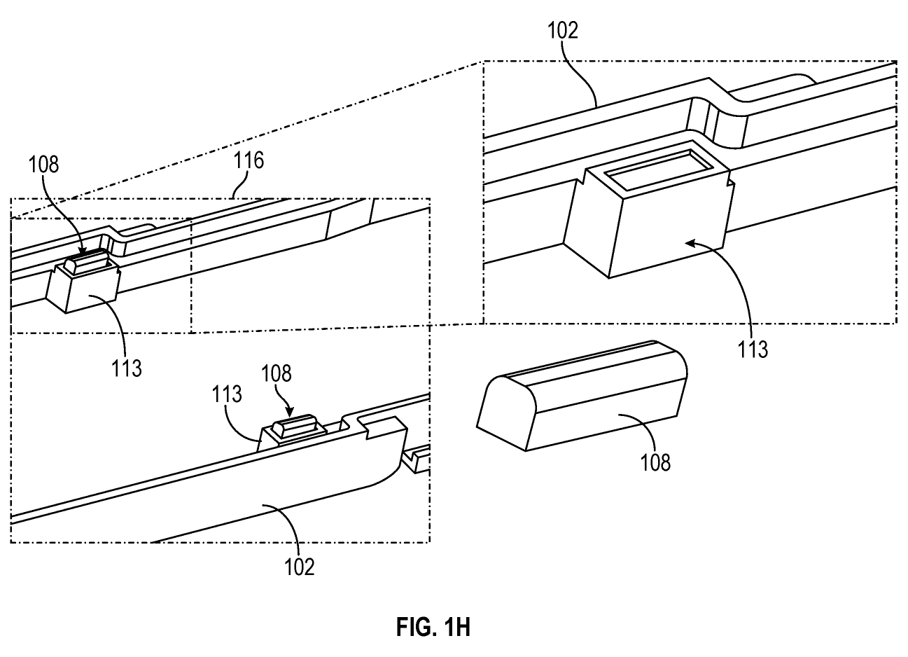

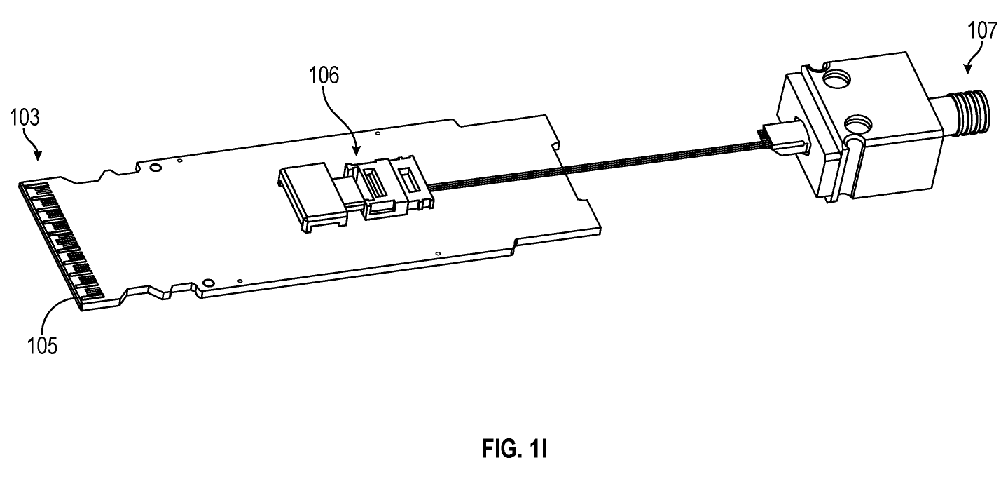

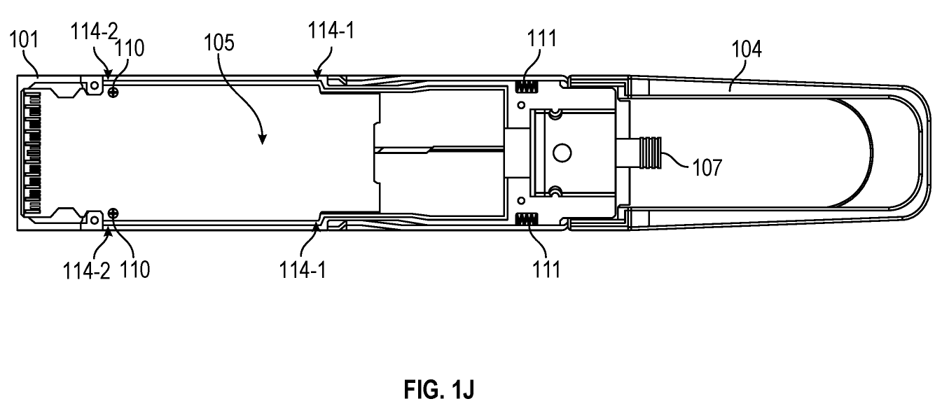

FIG. 1A shows an optical module 100 according to one or more implementations. The optical module 100 includes a first housing body 101, a second housing body 102, a PCBA 103, and a pull-tab 104. The first housing body 101 and the second housing body 102 may form a housing of the optical module 100. For example, the second housing body 102 may be fastened to the first housing body 101 to form an enclosure that defines an interior volume of the housing in which the PCBA 103 is arranged.

The first housing body 101 and the second housing body 102 may be made of a metal material. For example, the first housing body 101 and the second housing body 102 may be metal bodies that provide electromagnetic shielding and heat dissipation. The first housing body 101 and the second housing body 102 may be assembled together with the internal volume defined by the first housing body 101 and the second housing body 102. In other words, the first housing body 101 and the second housing body 102 may lock together to form a protective housing, inside which the PCBA 103 and other internal parts are arranged. The PCBA 103 may include a PCB, optoelectronic devices, optical fibers, and connectors, which, together, achieve optoelectronic conversion and control. The PCB may be used as a carrier substrate of optoelectronic components. The first housing body 101 and the second housing body 102 may protect the internal parts and may be configured to dissipate heat generated by one or more internal components.

The pull-tab 104 may be used to plug the optical module 100 into, and/or unplug the optical module 100 from, a receptacle (e.g., to insert or remove the optical module 100). The pull-tab 104 may function as a handle.

As indicated above, FIG. 1A is provided as an example. Other examples may differ from what is described with regard to FIG. 1A.

FIG. 1B shows an exploded view of the optical module 100. In addition to the first housing body 101, the second housing body 102, the PCBA 103, and the pull-tab 104, the optical module 100 may include a PCB 105 and one or more components 106 mounted to the PCB 105. The PCB 105 and the one or more components 106 may be part of the PCBA 103. The one or more components 106 may include at least one optoelectronic component. The PCB 105 includes an upper surface (e.g., a surface facing the first housing body 101) and a bottom surface (e.g., a surface facing the second housing body 102) arranged opposite to the upper surface. In addition, the optical module 100 may include an optical port 107, elastic bodies 108, a first plurality of fasteners 109, a hard-constraint fixing mechanism 110 (e.g., a second plurality of fasteners), and springs 111.

The first plurality of fasteners 109 and the second plurality of fasteners may be screws or other types of mechanical fasteners. The first plurality of fasteners 109 may be used to fasten the first housing body 101 and the second housing body 102 together by use of respective through-holes. The first plurality of fasteners 109 may be symmetrically arranged on both ends of the optical module 100. For example, there may be two or four fasteners 109.

The hard-constraint fixing mechanism 110 may rigidly fix a first end portion of the PCB 105 to the first housing body 101. The hard-constraint fixing mechanism 110 may include a second plurality of fasteners that fasten the first end portion of the PCB 105 to the first housing body 101. In some examples, the second plurality of fasteners may include two screws arranged at the first end portion of the PCB 105 for fastening the first end portion of the PCB 105 to the first housing body 101. Thus, the second plurality of fasteners may serve as the hard-constraint fixing mechanism 110.

A “lug boss” may be a protruding feature, a mounting feature, a recessed feature, a holding feature, a constraining feature, and/or a pocket feature on a workpiece defined by one or more structures of the workpiece. The first housing body 101 may include a plurality of first lug bosses (e.g., first lug bosses 114 shown in FIG. 1E) configured to be in fitted contact with the upper surface of the PCB 105. The second housing body 102 may define a recess 112 that forms part of the interior volume of the housing. In addition, the second housing body 102 may include a plurality of second lug bosses (e.g., second lug bosses 113) arranged at locations corresponding to a second end portion of the PCB 105. The second lug bosses 113 may be arranged at a perimeter of the recess 112. Each second lug boss 113 may contain a respective elastic body 108, which protrudes from the second lug boss 113 to make pressure contact with the bottom surface of the PCB 105. Thus, each second lug boss 113 may be used to make contact with a respective elastic body 108, which creates pressure contact between the respective elastic body 108 and the PCB 105 of the PCBA 103. Due to an elastic property of the elastic bodies 108, the plurality of second lug bosses may be in pressure contact with the bottom surface of the PCB 105. The elastic bodies 108 may serve as an elastic-constraint fixing mechanism configured to elastically constrain the second end portion of the PCB 105 between the first housing body 101 and the second housing body 102.

Each elastic body 108, arranged at respective second lug boss 113, may be made of elastic material. For example, the elastic bodies 108 may be formed by applying adhesive and solidifying the adhesive at corresponding positions of the lug bosses or the PCB 105. Alternatively, the elastic bodies 108 may be formed by directly placing soft gaskets to achieve the purpose of adding flexible constraints to the PCB 105. In some implementations, the elastic bodies 108 are soft gaskets and/or molded elastic (e.g., molded rubber, molded adhesive, or molded gel that has been cured).

The optical port 107 may receive or transmit an optical signal. The optical port 107 may be optically coupled to at least one optoelectronic component of the one or more components 106.

The springs 111 may cooperate with the pull-tab 104 for resetting the pull-tab 104.

As indicated above, FIG. 1B is provided as an example. Other examples may differ from what is described with regard to FIG. 1B.

FIG. 1C shows the optical module 100, including an underside of the first housing body 101, and a top side of the second housing body 102. The first end portion of the PCB 105 may be fastened to the first housing body 101 by the hard-constraint fixing mechanism 110. The elastic bodies 108 may be inserted into the second lug bosses 113, respectively. The elastic bodies 108 may protrude from the second lug bosses 113 to make pressure contact with the bottom surface of the PCB 105. The plurality of second lug bosses 113 may define respective recesses in which the elastic bodies 108 are arranged. In other words, the second lug bosses 113 may be container structures in which the elastic bodies 108 are arranged, respectively.

As indicated above, FIG. 1C is provided as an example. Other examples may differ from what is described with regard to FIG. 1C.

FIG. 1D shows a top view of the optical module 100 with a sectional line A-A. FIG. 1D shows the first housing body 101, the pull-tab 104, and the optical port 107. The PCB 105 can also be observed to be within the internal volume.

As indicated above, FIG. 1D is provided as an example. Other examples may differ from what is described with regard to FIG. 1D.

FIG. 1E shows a cross-section of the optical module 100 at sectional line A-A.

The first housing body 101 and the second housing body 102 are fastened together to form an enclosure that defines an interior volume of the housing. The interior volume may include a lower portion (e.g., recess 112) defined by the second housing body 102 and an upper portion (e.g., recess 115) defined by the first housing body 101. The first housing body 101 may include first lug bosses 114 configured to be in fitted contact with the upper surface of the PCB 105. The first lug bosses 114 may be arranged at an interior periphery of the first housing body 101. The first lug bosses 114 may include a first subset of first lug bosses 114-1 arranged over the second end portion of the PCB 105, and a second subset of first lug bosses 114-2 arranged over the first end portion of the PCB 105 (e.g., as shown in FIG. 1F). The first lug bosses 114 may be stepped protrusions that conform to a shape of the PCB 105. For example, the first lug bosses 114 may conform to respective edges of the PCB 105 such that the PCB 105 is in fitted contact with the first lug bosses 114. Thus, the first lug bosses 114 may constrain edges of the upper surface and side surfaces of the PCB 105.

The second housing body 102 may include second lug bosses 113 arranged at locations corresponding to the second end portion of the PCB 105. The second lug bosses 113 may be arranged at an interior periphery of the second housing body 102. In some examples, the second lug bosses 113 may be aligned vertically with the first subset of first lug bosses 114-1. The elastic bodies 108 may protrude from the second lug bosses 113, respectively, to make pressure contact with the bottom surface of the PCB 105. The elastic bodies 108 may be compressed between the PCB 105 and the second housing body 102 based on the second housing body 102 being fastened to the first housing body 101.

As shown in FIG. 1E, the second end portion of the PCB 105 may be constrained between the elastic bodies 108 and the first subset of first lug bosses 114-1. The elastic bodies 108 may be configured to push the second end portion of the PCB 105 into the first subset of first lug bosses 114-1 such that the second end portion of the PCB 105 makes pressure contact with the first subset of first lug bosses 114-1. As a result, the elastic bodies 108 may form an elastic-constraint fixing mechanism for elastically constraining the second end portion of the PCB 105 between the first housing body 101 and the second housing body 102.

The PCB 105 may expand and contract with temperature changes. For example, the PCB 105 may expand with temperature increases, and may contract with temperature decreases. The elastic bodies 108 may be configured to increase a pressure of the pressure contact as the PCB 105 expands, and may be configured to decrease the pressure of the pressure contact as the PCB 105 contracts. Thus, the elastic bodies 108 provide an elastic-constraint fixing mechanism that may allow the PCB 105 to expand and contract to allow some deformation, while elastically constraining the PCB 105 between the first housing body 101 and the second housing body 102 to prevent an amount of deformation that may damage the PCBA 103. The elastic bodies 108 enable thermal expansion of the PCB 105 such that expansion deformation of the PCB 105 is reduced. Additionally, the elastic bodies 108 may dampen external vibrations to reduce the external vibrations propagating from the housing to the PCB 105.

The bottom surface of the PCB 105 may rest on top of the elastic bodies 108 with pressure contact. Moreover, the elastic bodies 108 may create a pressure contact with an upper surface of the PCB 105 and the first subset of first lug bosses 114-1 of the first housing body 101. For example, when the first housing body 101 and the second housing body 102 are fastened together, the PCB 105 may be arranged in mechanical contact between the first subset of first lug bosses 114-1 and the elastic bodies 108, with the elastic bodies 108 being partially compressed between the PCB 105 and the second housing body 102 (e.g., between the PCB 105 and the second lug bosses 113). As a result, the elastic bodies 108 may be in pressure contact with the PCB 105 to provide an elastic (flexible) constraint fixing mechanism. As the PCB 105 expands with temperature, the pressure contact may increase to prevent deformation, while not being so rigid that the PCB 105 buckles or lifts up to a point where the components 106 mounted to the PCB 105 are at risk of damage or failure. Moreover, the elastic-constraint fixing mechanism may enable an electromagnetic shielding effect of the two housing bodies 101 and 102 to be maintained during high operating temperatures of the PCBA 103. When the PCB 105 contracts, the pressure contact may decrease. However, a minimum amount of pressure contact is maintained during lower temperatures. Thus, the elastic bodies 108 may increase stability, may permit some expansion/deformation without jeopardizing a structural integrity of the PCBA 103, may dampen vibrations, and/or may maintain an integrity of the electromagnetic shielding effect.

As indicated above, FIG. 1E is provided as an example. Other examples may differ from what is described with regard to FIG. 1E.

FIG. 1F shows the underside of the first housing body 101 with first lug bosses 114 being shown. The first subset of first lug bosses 114-1 may be arranged over the second end portion of the PCB 105. The second subset of first lug bosses 114-2 may be arranged over the first end portion of the PCB 105. In addition, the second subset of first lug bosses 114-2 may include bore holes for receiving fasteners of the hard-constraint fixing mechanism 110. Thus, the first end portion of the PCB 105 may be rigidly fixed to the second subset of first lug bosses 114-2, and the second end portion of the PCB 105 may be constrained, at least in part, by the first subset of first lug bosses 114-1.

As indicated above, FIG. 1F is provided as an example. Other examples may differ from what is described with regard to FIG. 1F.

FIG. 1G shows a topside of the second housing body 102. The second housing body 102 may include at least two second lug bosses 113 in region 116 of the second housing body 102. The second lug bosses 113 may be arranged on opposite sides of the second housing body 102.

As indicated above, FIG. 1G is provided as an example. Other examples may differ from what is described with regard to FIG. 1G.

FIG. 1H shows a zoomed-in view of region 116 of the second housing body 102 shown in FIG. 1G. Each second lug boss 113 may be designed to receive a respective elastic body 108, which may be inserted into a recess, a pocket, or a volume defined by the second lug boss 113. Thus, each second lug boss 113 may be a container for a respective elastic body 108. The elastic bodies 108 may be designed to partially protrude from the second lug bosses 113 to make contact with the bottom surface of the PCB 105.

As indicated above, FIG. 1H is provided as an example. Other examples may differ from what is described with regard to FIG. 1H.

FIG. 1I shows the PCBA 103 with components 106 mounted to the PCB 105. An optoelectrical component may be optically coupled to the optical port 107 of the optical module 100.

As indicated above, FIG. 1I is provided as an example. Other examples may differ from what is described with regard to FIG. 1I.

FIG. 1J shows the underside of the first housing body 101 and the pull-tab 104. The PCB 105 of the PCBA 103 may overlap with the first lug bosses 114 (e.g., first lug bosses 114-1 and 114-2). Fasteners of the hard-constraint fixing mechanism 110 may be used to fasten the PCB 105 of the PCBA 103 to the first housing body 101. The fasteners of the hard-constraint fixing mechanism 110 may fasten into bore holes of the second subset of first lug bosses 114-2. The springs 111 may be mounted to the first housing body 101 and may cooperate with the pull-tab 104 for operating the pull-tab 104.

As indicated above, FIG. 1J is provided as an example. Other examples may differ from what is described with regard to FIG. 1J.

The following provides an overview of some Aspects of the present disclosure:

Aspect 1: An optical module, comprising: a PCBA comprising a PCB and one or more optoelectronic components mounted to the PCB, wherein the PCB includes an upper surface and a bottom surface arranged opposite to the upper surface; an optical port for receiving or transmitting an optical signal, wherein the optical port is optically coupled to the one or more optoelectronic components; a plurality of elastic bodies; a housing comprising a first housing body and a second housing body fastened to the first housing body to form an enclosure that defines an interior volume of the housing, wherein the PCBA is arranged within the interior volume, wherein the first housing body includes a plurality of first lug bosses configured to be in fitted contact with the upper surface of the PCB, wherein the second housing body includes a plurality of second lug bosses, and wherein each second lug boss of the plurality of second lug bosses contains a respective elastic body of the plurality of elastic bodies, which protrudes from the second lug boss to make pressure contact with the bottom surface of the PCB; and a hard-constraint fixing mechanism configured to rigidly fix a first end portion of the PCB to the first housing body.

Aspect 2: The optical module of Aspect 1, wherein the hard-constraint fixing mechanism includes a plurality of fasteners that fasten the first end portion of the PCB to the first housing body.

Aspect 3: The optical module of any of Aspects 1-2, wherein the plurality of first lug bosses includes a first subset of first lug bosses arranged over a second end portion of the PCB, and wherein the second end portion of the PCB is constrained between the plurality of elastic bodies and the first subset of first lug bosses.

Aspect 4: The optical module of Aspect 3, wherein the plurality of first lug bosses includes a second subset of first lug bosses arranged over the first end portion of the PCB.

Aspect 5: The optical module of Aspect 3, wherein the plurality of elastic bodies are configured to push the second end portion of the PCB into the first subset of first lug bosses to make pressure contact with the first subset of first lug bosses.

Aspect 6: The optical module of any of Aspects 1-5, wherein the plurality of elastic bodies forms an elastic-constraint fixing mechanism for elastically constraining a second end portion of the PCB between the first housing body and the second housing body.

Aspect 7: The optical module of any of Aspects 1-6, wherein the plurality of elastic bodies are configured to increase a pressure of the pressure contact as the PCB expands, and the plurality of elastic bodies are configured to decrease the pressure of the pressure contact as the PCB contracts.

Aspect 8: The optical module of any of Aspects 1-7, wherein the plurality of first lug bosses are stepped protrusions that conform to a shape of the PCB.

Aspect 9: The optical module of any of Aspects 1-8, wherein the plurality of first lug bosses are stepped protrusions that conform to edges of the PCB.

Aspect 10: The optical module of any of Aspects 1-9, wherein the plurality of second lug bosses define respective recesses in which the plurality of elastic bodies are arranged, respectively.

Aspect 11: The optical module of any of Aspects 1-10, wherein the plurality of second lug bosses are container structures in which the plurality of elastic bodies are arranged, respectively.

Aspect 12: The optical module of any of Aspects 1-11, wherein the plurality of elastic bodies are configured to be compressed between the PCB and the second housing body based on the second housing body being fastened to the first housing body.

Aspect 13: The optical module of any of Aspects 1-12, wherein the plurality of first lug bosses are arranged at an interior periphery of the first housing body, and wherein the plurality of second lug bosses are arranged at an interior periphery of the second housing body.

Aspect 14: An optical module, comprising: a PCBA comprising a PCB and one or more optoelectronic components mounted to the PCB, wherein the PCB includes an upper surface and a bottom surface arranged opposite to the upper surface; an optical port for receiving or transmitting an optical signal, wherein the optical port is optically coupled to the one or more optoelectronic components; a housing comprising a first housing body and a second housing body fastened to the first housing body to form an enclosure that defines an interior volume of the housing in which the PCBA is arranged, wherein the first housing body includes a plurality of first lug bosses configured to be in fitted contact with the upper surface of the PCB, and wherein the second housing body includes a plurality of second lug bosses configured to be in pressure contact with the bottom surface of the PCB; a hard-constraint fixing mechanism configured to rigidly fix a first end portion of the PCB to the first housing body; and an elastic-constraint fixing mechanism configured to elastically constrain a second end portion of the PCB between the first housing body and the second housing body.

Aspect 15: The optical module of Aspect 14, wherein the elastic-constraint fixing mechanism includes a plurality of elastic bodies arranged at the plurality of second lug bosses, respectively, and wherein the plurality of elastic bodies are configured to provide pressure contact between the bottom surface of the PCB and the second housing body.

Aspect 16: The optical module of Aspect 15, wherein the plurality of elastic bodies are configured to push the second end portion of the PCB into a subset of the plurality of first lug bosses to make pressure contact with the subset of the plurality of first lug bosses.

Aspect 17: The optical module of Aspect 15, wherein the plurality of elastic bodies are configured to be compressed between the PCB and the second housing body based on the second housing body being fastened to the first housing body.

Aspect 18: The optical module of Aspect 15, wherein the plurality of elastic bodies are configured to enable thermal expansion of the PCB such that expansion deformation of the PCB is reduced.

Aspect 19: The optical module of Aspect 15, wherein the plurality of elastic bodies are configured to dampen external vibrations to reduce the external vibrations propagating from the housing to the PCB.

Aspect 20: The optical module of Aspect 15, wherein the first housing body and the second housing body are metal bodies that provide electromagnetic shielding and heat dissipation.

Aspect 21: A system configured to perform one or more operations recited in one or more of Aspects 1-20.

Aspect 22: An apparatus comprising means for performing one or more operations recited in one or more of Aspects 1-20.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature’s relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical module, comprising:
a printed circuit board assembly (PCBA) comprising a printed circuit board (PCB) and one or more optoelectronic components mounted to the PCB, wherein the PCB includes an upper surface and a bottom surface arranged opposite to the upper surface;
an optical port for receiving or transmitting an optical signal, wherein the optical port is optically coupled to the one or more optoelectronic components;
a plurality of elastic bodies;
a housing comprising a first housing body and a second housing body fastened to the first housing body to form an enclosure that defines an interior volume of the housing,
wherein the PCBA is arranged within the interior volume,
wherein the first housing body includes a plurality of first lug bosses configured to be in fitted contact with the upper surface of the PCB,
wherein the second housing body includes a plurality of second lug bosses, and
wherein each second lug boss of the plurality of second lug bosses contains a respective elastic body of the plurality of elastic bodies, which protrudes from the second lug boss to make pressure contact with the bottom surface of the PCB; and
a hard-constraint fixing mechanism configured to rigidly fix a first end portion of the PCB to the first housing body.

2. The optical module of claim 1, wherein the hard-constraint fixing mechanism includes a plurality of fasteners that fasten the first end portion of the PCB to the first housing body.

3. The optical module of claim 1, wherein the plurality of first lug bosses includes a first subset of first lug bosses arranged over a second end portion of the PCB, and
wherein the second end portion of the PCB is constrained between the plurality of elastic bodies and the first subset of first lug bosses.

4. The optical module of claim 3, wherein the plurality of first lug bosses includes a second subset of first lug bosses arranged over the first end portion of the PCB.

5. The optical module of claim 3, wherein the plurality of elastic bodies are configured to push the second end portion of the PCB into the first subset of first lug bosses to make pressure contact with the first subset of first lug bosses.

6. The optical module of claim 1, wherein the plurality of elastic bodies forms an elastic-constraint fixing mechanism for elastically constraining a second end portion of the PCB between the first housing body and the second housing body.

7. The optical module of claim 1, wherein the plurality of elastic bodies are configured to increase a pressure of the pressure contact as the PCB expands, and the plurality of elastic bodies are configured to decrease the pressure of the pressure contact as the PCB contracts.

8. The optical module of claim 1, wherein the plurality of first lug bosses are stepped protrusions that conform to a shape of the PCB.

9. The optical module of claim 1, wherein the plurality of first lug bosses are stepped protrusions that conform to edges of the PCB.

10. The optical module of claim 1, wherein the plurality of second lug bosses define respective recesses in which the plurality of elastic bodies are arranged, respectively.

11. The optical module of claim 1, wherein the plurality of second lug bosses are container structures in which the plurality of elastic bodies are arranged, respectively.

12. The optical module of claim 1, wherein the plurality of elastic bodies are configured to be compressed between the PCB and the second housing body based on the second housing body being fastened to the first housing body.

13. The optical module of claim 1, wherein the plurality of first lug bosses are arranged at an interior periphery of the first housing body, and
wherein the plurality of second lug bosses are arranged at an interior periphery of the second housing body.

14. An optical module, comprising:
a printed circuit board assembly (PCBA) comprising a printed circuit board (PCB) and one or more optoelectronic components mounted to the PCB, wherein the PCB includes an upper surface and a bottom surface arranged opposite to the upper surface;
an optical port for receiving or transmitting an optical signal, wherein the optical port is optically coupled to the one or more optoelectronic components;
a housing comprising a first housing body and a second housing body fastened to the first housing body to form an enclosure that defines an interior volume of the housing in which the PCBA is arranged,
wherein the first housing body includes a plurality of first lug bosses configured to be in fitted contact with the upper surface of the PCB, and
wherein the second housing body includes a plurality of second lug bosses configured to be in pressure contact with the bottom surface of the PCB;
a hard-constraint fixing mechanism configured to rigidly fix a first end portion of the PCB to the first housing body; and
an elastic-constraint fixing mechanism configured to elastically constrain a second end portion of the PCB between the first housing body and the second housing body.

15. The optical module of claim 14, wherein the elastic-constraint fixing mechanism includes a plurality of elastic bodies arranged at the plurality of second lug bosses, respectively, and
wherein the plurality of elastic bodies are configured to provide pressure contact between the bottom surface of the PCB and the second housing body.

16. The optical module of claim 15, wherein the plurality of elastic bodies are configured to push the second end portion of the PCB into a subset of the plurality of first lug bosses to make pressure contact with the subset of the plurality of first lug bosses.

17. The optical module of claim 15, wherein the plurality of elastic bodies are configured to be compressed between the PCB and the second housing body based on the second housing body being fastened to the first housing body.

18. The optical module of claim 15, wherein the plurality of elastic bodies are configured to enable thermal expansion of the PCB such that expansion deformation of the PCB is reduced.

19. The optical module of claim 15, wherein the plurality of elastic bodies are configured to dampen external vibrations to reduce the external vibrations propagating from the housing to the PCB.

20. The optical module of claim 15, wherein the first housing body and the second housing body are metal bodies that provide electromagnetic shielding and heat dissipation.
